(19) United States
(12) Patent Application Publication
(10) Pub. No.: US 2024/0311761 A1
(43) Pub. Date: Sep. 19, 2024

(54) MULTIPLAYER COLLABORATIVE TASK ASSURANCE METHOD BASED ON AGENT AND BACKUP TECHNIQUES

(71) Applicant: 38TH RESEARCH INSTITUTE,CHINA ELECTRONICS TECHNOLOGY GROUP CORPORATION, Hefei (CN)

(72) Inventors: Hongqi ZHANG, Hefei (CN); Rui CAO, Hefei (CN); Wusi CHENG, Hefei (CN); Qianhao WU, Hefei (CN); Lei GUO, Hefei (CN)

(21) Appl. No.: 18/671,946

(22) Filed: May 22, 2024

Related U.S. Application Data
(63) Continuation of application No. PCT/CN2023/094449, filed on May 16, 2023.

(30) Foreign Application Priority Data
Dec. 30, 2022 (CN) 202211729341.3

(51) Int. Cl. G06Q 10/101; H04L 9/40

(52) U.S. Cl. CPC G06Q 10/101; H04L 63/102

(57) ABSTRACT

A multiplayer collaborative task assurance method is provided. Parameter information of a virtual device is acquired as a first parameter information, and input into a pre-trained target model to obtain model results. A model result with a highest priority is acquired as a first model result and is sent to the collaborative client. The collaborative client updates a local model to obtain an updated result. Feedback information is sent to the server based on the updated result. Whether a proportion of the approved opinion in the feedback information exceeds a preset value is determined; if yes, the parameter information in the virtual device is updated. Whether the first model result is correct is determined; if yes, a confirmation message is sent to the collaborative client to continue the multiplayer collaborative task.

### CROSS-REFERENCE TO RELATED APPLICATIONS

This application is a continuation of International Patent Application No. PCT/CN2023/094449, filed on May 16, 2023, which claims the benefit of priority from Chinese Patent Applications No. 202211729341.3, filed on Dec. 30, 2022. The content of the aforementioned application, including any intervening amendments thereto, is incorporated herein by reference in its entirety.

### TECHNICAL FIELD

This application relates to software technologies, and more specifically to a multiplayer collaborative task assurance method based on agent and backup technologies.

### BACKGROUND

With the development of the new generation of information technology and manufacturing technology, digital twin technology, as the future trend of intelligent manufacturing, increasingly reflects the strategic value in the industrial industry. Among them, one of the typical application scenarios of the digital twin technology is multi-person cooperation, that is, multi-person operation on a virtual equipment model constructed using digital simulation technology, including assembly or maintenance training instruction teaching, multi-person cooperation maintenance for factory equipment, and multi-worker co-operation assembly for production line equipment. For example, for a complex system containing multiple devices in the factory, multiple skilled technicians are required when overhauled. Based on digital twin technology, the complex system can be mapped in the virtual space of the server to obtain corresponding virtual equipment. After that, technicians use their own clients to connect with the server to carry out collaborative overhauling operations on the virtual equipment to obtain overhaul results of the virtual equipment that is used as overhaul results of the complex system in the actual work.

During the above multiplayer collaborative task, when encountering network resource constraints or sudden failure of the client device, one or more users will be unable to continue to participate in the multiplayer collaborative task, interrupting the multiplayer collaborative task and thereby prolonging the completion time of the multiplayer collaborative task.

Therefore, it is urgent to develop an assurance method for a multiplayer collaborative task to solve the above problem.

### SUMMARY

In view of deficiencies in the prior art, an objective of the present disclosure is to provide a multiplayer collaborative task assurance method based on agent and backup technologies to overcome the problem of delaying time for the multiplayer collaborative task due to the interruption of the multiplayer collaborative task when one or more users are unable to continue to participate in the multiplayer collaborative task.

Technical solutions of the present disclosure are described below.

In a first aspect, this application provides a multiplayer collaborative task assurance system based on agent and backup technologies, comprising:
a server;
a target client; and
a collaborative client;
wherein the server is configured to perform:
obtaining parameter information of a virtual device as a first parameter information after determining to be disconnected from the target client;
inputting the first parameter information into a pre-trained target model to obtain a plurality of model results output from the pre-trained target model; and
acquiring a model result with a highest priority among the plurality of model results as a first model result, and sending the first model result to the collaborative client;
wherein a user of any client corresponds to a pre-trained model belonging to the user; the target model represents a model of a user belonging to the target client; the virtual device represents a processing object of a multiplayer collaborative task; and the number of the plurality of model results is a first preset value;
the collaborative client is configured to perform:
updating a local model within the collaborative client based on the first model result and obtaining an updated result; and sending feedback information to the server based on the updated result;
wherein the local model has the same structure and parameter information as the virtual device, and the feedback information comprises an approved opinion and a disapproved opinion; and
the server is configured to perform:
determining whether a proportion of the approved opinion in the feedback information exceeds a second preset value;
if yes, updating the parameter information in the virtual device based on the first model result to obtain an updated parameter information as a second parameter information; and determining whether the first model result is correct based on the second parameter information; if yes, sending a confirmation message to the collaborative client to continue the multiplayer collaborative task.

In a second aspect, this application provides a multiplayer collaborative task assurance method based on agent and backup techniques, being applied to a sever of a multiplayer collaborative task assurance system based on agent and backup technologies, the multiplayer collaborative task assurance system further comprising a target client and a collaborative client, wherein the multiplayer collaborative task assurance method comprising:
acquiring parameter information of a virtual device as a first parameter information after it is determined that the server is disconnected from the target client, wherein the virtual device represents a processing object of a multiplayer collaborative task;
inputting the first parameter information into a pre-trained target model to obtain a plurality of model results output from the pre-trained target model, wherein a user of any client corresponds to a pre-trained model belonging to the user; the target model represents a model of a user belonging to the target client; and the number of the plurality of model results is a first preset value;
acquiring a model result with a highest priority from the plurality of model results as a first model result, and sending the first model result to the collaborative client such that the collaborative client updates a local model in the collaborative client based on the first model result and obtains a first updated result; and sending a first feedback information to the server based on the first updated result; wherein the local model has the same structure and parameter information as the virtual device, and the first feedback information comprises an approved opinion and a disapproved opinion;
determining whether a proportion of the approved opinion in the feedback information exceeds a second preset value; if yes, updating the parameter information in the virtual device based on the first model result to obtain a second parameter information; and
determining whether the first model result is correct based on the second parameter information; if yes, sending a confirmation message to the collaborative client to continue the multiplayer collaborative task.

In some embodiments, the multiplayer collaborative task assurance method further comprises:
if the proportion of the approved opinion in the feedback information does not exceed the second preset value, sending an undo instruction to the collaborative client to allow the collaborative client to cancel an operation of updating the local model;
selecting the plurality of model results one by one to replace the first model result according to a priority order among the plurality of model results to obtain a plurality of second model results; sending each of the plurality of second model results to the collaborative client to re-update the local model based on each of the plurality of second model results and obtain a plurality of second updated results; and re-sending a second feedback information to the server based on the plurality of second updated results;
if a proportion of the approved opinion in the second feedback information received by the server exceeds the second preset value after the first model result is replaced with one of the plurality of model results, updating the parameter information in the virtual device based on the one of the plurality of model results to obtain an updated parameter information as the second parameter information; and
for all of the plurality of second model results, if the proportion of the approved opinion in the second feedback information received by the server does not exceed the second preset value, pausing the multiplayer collaborative task and sending a confirmation instruction to the collaborative client to allow the collaborative client to determine whether to continue the multiplayer collaborative task.

In some embodiments, the server is disconnected from the target client through steps of:
disconnecting, by the server, to be disconnected from the target client according to a heartbeat mechanism; or
receiving, by the server, a disconnection instruction sent by the target client.

In some embodiments, the multiplayer collaborative task assurance method further comprises:
when a user joins the multiplayer collaborative task for the first time, obtaining user data information of the user and constructing a user object of the user; wherein user objects of different users have different ranges of permissions to perform the multiplayer collaborative task; and a target user object represents a user object of the target client, and a collaborative user object represents a user object of the collaborative client;
backing up the user object as a backup user object; and sending the backup user object to remaining clients; wherein the server comprises a backup target user object and a backup collaborative user object; the target client comprises the target user object and the backup collaborative user object, and the collaborative client comprises the collaborative user object and the backup target user object;
when the server is not disconnected from the target client, receiving an operation instruction sent by the target client as a first operation instruction;
based on the first operation instruction, updating the parameter information of the virtual device to obtain a third parameter information; and
based on the third parameter information, determining whether the first operation instruction is correct; if yes, storing the third parameter information and the first operation instruction into a database of the server, and sending the first operation instruction to the target client and the collaborative client to allow the target client and the collaborative client to store the first operation instruction and update the local model based on the first operation instruction.

In some embodiments, the multiplayer collaborative task assurance method further comprises:
if the first operation instruction is incorrect, undoing, by the server, an operation of updating the parameter information of the virtual device based on the first operation instruction; and
sending an error confirmation message to the target client such that the target client adjusts the first operation instruction and sends an adjusted first operation instruction to the server.

In some embodiments, the multiplayer collaborative task assurance method further comprises:
after reconnected with the target client, receiving, by the server, a re-connection instruction sent by the target client; wherein the re-connection instruction comprises a task identification (ID) of the multiplayer collaborative task and an operation sequence number of a last operation instruction sent by the target client before disconnection; and
based on the task ID and the operation sequence number, synchronizing, by the server, information of all operations after the operation sequence number in the task ID to the target client.

In a third aspect, this application provides a multiplayer collaborative task assurance device, being applied to a sever of a multiplayer collaborative task assurance system based on agent and backup techniques, the multiplayer collaborative task assurance system further comprising a target client and a collaborative client, wherein the multiplayer collaborative task assurance device comprises:
a first acquisition module;
a second acquisition module;
a third acquisition module;
a judgement module;
a confirmation module; and
a sending module;
wherein the first acquisition module is configured to acquire parameter information of a virtual device as a first parameter information after the server is determined to be disconnected from the target client, wherein the virtual device represents a processing object of a multiplayer collaborative task;
the second acquisition module is configured to input the first parameter information into a pre-trained target model to obtain a plurality of model results output from the pre-trained target model, wherein a user of any client corresponds to a pre-trained model belonging to the user; the target model represents a model of a user belonging to the target client; and the number of the plurality of model results is a first preset value;
the third acquisition module is configured to acquire a model result with a highest priority from the plurality of model results as a first model result, send the first model result to the collaborative client to allow the collaborative client to update a local model in the collaborative client based on the first model result and obtain an updated result, and send a feedback information to the server based on the updated result; wherein the local model has the same structure and parameter information as the virtual device, and the feedback information comprises an approved opinion and a disapproved opinion;
the judgement module is configured to perform:
judging whether a proportion of the approved opinion in the feedback information exceeds a second preset value; and
if yes, updating the parameter information in the virtual device based on the first model result to obtain a second parameter information;
the confirmation module is configured to confirm whether the first model result is correct based on the second parameter information; and
the sending module is configured to send a confirmation message to the collaborative client to continue the multiplayer collaborative task after the first model result is confirmed to be correct.

In a fourth aspect, this application provides an electronic device, comprising:
a processor;
a communication interface;
a memory; and
a communication bus;
wherein the processor, the communication interface and the memory are in communication with each other via the communication bus;
the memory is configured to store a computer program; and
the processor is configured to execute the computer program stored on the memory to implement the aforementioned multiplayer collaborative task assurance method.

In a fifth aspect, this application provides a computer-readable storage medium, wherein the computer-readable storage medium is configured to store a computer program, and the computer program is configured to be executed by a processor to implement the aforementioned multiplayer collaborative task assurance method.

The present disclosure has at least the following beneficial effects compared with the prior art.

The server is configured to obtain parameter information of a virtual device as a first parameter information after disconnecting from the target client, input the first parameter information into a pre-trained target model to obtain a plurality of model results output from the pre-trained target model, acquire a model result with a highest priority among the plurality of model results as a first model result, and send the first model result to the collaborative client. The collaborative client is configured to update a local model in the collaborative client based on the first model result and obtain an updated result, and send feedback information to the server based on the updated result. The server is configured to determine whether a proportion of the approved opinion in the feedback information exceeds a second preset value; if yes, the server is configured to update the parameter information in the virtual equipment based on the first model result to obtain an updated parameter information as a second parameter information. The server is further configured to determine whether the first model result is correct based on the second parameter information; if yes, the server is configured to send a confirmation message to the collaborative client to continue the multiplayer collaborative task.

After the target client is disconnected from the server, the pre-trained target model in the server is configured to simulate the operation of the user of the target client to update the parameter information of the virtual device, thus guaranteeing the smooth and efficient conduct of the multiplayer collaborative task. At the same time, based on the feedback information of the collaborative client and the confirmation operation of the server, whether the model results output by the selected pre-trained target model are correct is judged, thereby verifying the feasibility of the updated parameter information of the virtual device, and avoiding deviation in the process of carrying out the multiplayer collaborative task.

### BRIEF DESCRIPTION OF THE DRAWINGS

To more clearly illustrate the technical solutions in the embodiments or the prior art of the present invention, the accompanying drawings that need to be used in the description of the embodiments or the prior art will be briefly introduced. Obviously, the accompanying drawings in the following description are only some of the embodiments of the present disclosure, and other accompanying drawings can be obtained by one of ordinary skill in the art according to these drawings without paying any creative labor.

FIG. 1 is a schematic diagram of a multiplayer collaborative task assurance system according to an embodiment of the present disclosure;

FIG. 2 is a flow chart of a multiplayer collaborative task assurance method according to an embodiment of the present disclosure;

FIG. 3 schematically shows a multiplayer collaborative mechanism according to an embodiment of the present disclosure;

FIG. 4 is a timing diagram of the multiplayer collaborative mechanism according to an embodiment of the present disclosure;

FIG. 5 is a schematic diagram of a multiplayer collaborative task assurance device according to an embodiment of the present disclosure;

FIG. 6 is an electronic device according to an embodiment of the present disclosure;

### DETAILED DESCRIPTION OF EMBODIMENTS

To make the objectives, technical solutions and advantages of the embodiments of the present disclosure clearer, the technical solutions in the embodiments of the present disclosure are described clearly and completely. Obviously, the described embodiments are a part of the embodiments of the present disclosure. Based on the embodiments provided herein, all other embodiments obtained by one of ordinary skill in the art without making creative labor shall fall within the scope of protection of the present disclosure.

The embodiments of the present disclosure provide a multiplayer collaborative task assurance method based on agent and backup technologies, which solves the problem of interruption of the multiplayer collaborative task when one or more users are unable to continue to participate in the multiplayer collaborative task, ensuring the smooth and efficient conduct of the multiplayer collaborative task.

The technical solutions in the embodiments of the present disclosure are provided to solve the above technical problems, and the general ideas are as described as follows.

The two core issues of multiplayer collaborative technology are network performance and synchronization mechanisms. The network performance determines the speed of data synchronization between multiple clients in a collaborative task, the efficiency of the task, and the operating experience. The synchronization mechanism directly determines whether the operation of the virtual device between multiple users in a collaborative task can be accurately reflected, i.e., whether the state of the virtual device seen by different users is the same, and whether the different users can correctly cooperate with each other. The multiplayer collaborative task is performed based on the Internet for data transmission, and the network performance depends on the network service provider, which generally cannot be intervened and changed. However, the synchronization mechanism needs to be customized in each specific application scenario to ensure real-time data synchronization while saving network bandwidth resources as much as possible.

At present, under multiplayer operative scenarios of the virtual device model, the synchronization mechanism is generally designed based on good network transmission conditions, without considering other circumstances, such as network resource constraints and sudden equipment failures. Once encountering the above special circumstances, it is very likely to delay the multiplayer collaborative task, or even render the multiplayer collaborative task redone, causing a great waste of human and material resources.

To solve the above problems, in the technical solutions provided by the present disclosure, after the target client is disconnected from the server, the pre-trained target model in the server is utilized to simulate the user's operation of the target client to update the parameter information of the virtual device, thereby guaranteeing the smooth and efficient conduct of the multiplayer collaborative task. At the same time, based on the feedback information of the collaborative client and the confirmation operation of the server, whether the model result output from the selected pre-trained target model is correct is judged, and thus the feasibility of the updated parameter information of the virtual device is verified, thereby avoiding deviation in the process of carrying out the multiplayer collaborative task.

To better understand the aforementioned technical solutions, those technical solutions will be described in detail below with reference to the accompanying drawings and specific embodiments.

Firstly, a brief introduction to concepts involved in the present disclosure is provided below.

Prior to performing a multiplayer collaborative task, based on the digital twin technology, for a complex system containing one or more devices, mapping is performed in a virtual space of a server to obtain a virtual system stored in the server, where the virtual system contains one or more virtual devices that are in one-to-one correspondence with the devices in the original complex system.

After the virtual system is constructed, multiple operators (i.e., the users of the clients in the present disclosure) start to execute the multiplayer collaborative task. Firstly, the multiple operators respectively establish a connection between their own clients and the server. Then, based on their own client, each operator sends operation commands to the server through their own user object successively to operate the virtual device of the virtual system. Each user participating in the multiplayer collaborative task corresponds to a client to which it belongs. The virtual device represents a processing object of the multiplayer collaborative task.

The system for the multiplayer collaborative task includes a server and a plurality of clients. In an embodiment, a client that is applied to the virtual device serves as a target client, and the remaining clients other than the target client serve as collaborative clients. To prevent influences among a plurality of user objects when they are simultaneously operating on the virtual device, which may lead to confusion on changes in the parameter information of the virtual device, when a certain user is operating on the virtual device, the other user objects are not allowed to operate on the virtual device at the same time. It is understood that the number of the target client is 1, but the target client is not fixed and is constantly switched based on the sequence of different clients when performing the multiplayer collaborative task. The number of collaborative clients is 1 or more, and is subjected to the number of clients participating in the multiplayer collaborative task, which is not specifically limited herein.

When the target client is disconnected from the server, the operation instructions in the target client cannot be transmitted to the server, such that the server cannot operate the virtual device based on the operation instructions, resulting in the interruption of the multiplayer collaborative task, which greatly prolongs the time for completing the multiplayer collaborative task.

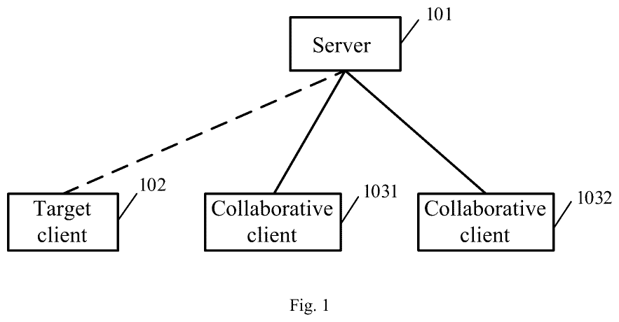

To solve the above problem, the present disclosure provides a multiplayer collaborative task assurance system based on agent and backup technologies. Referring to FIG. 1, FIG. 1 is a schematic diagram of a multiplayer collaborative task assurance system based on agent and backup technology provided by an embodiment of the present disclosure. The system includes a server 101, a target client 102, and a plurality of collaborative clients (including a collaborative client 1031 and a collaborative client 1032). Illustrated in FIG. 1 is only an example of the system that includes two collaborative clients, and the actual number of collaborative clients included in the system is not limited herein.

The server 101 is configured to obtain parameter information of a virtual device as a first parameter information after disconnecting from the target client 102, input the first parameter information into a pre-trained target model to obtain a plurality of model results output from the pre-trained target model, acquire a model result with a highest priority among the plurality of model results as a first model result, and send the first model result to the collaborative client 1031 and the collaborative client 1032.

A user of any client corresponds to a pre-trained model belonging to the user. The target model represents a model of a user belonging to the target client 102. The virtual device represents a processing object of a multiplayer collaborative task. The number of the plurality of model results is a first preset value.

The collaborative client 1031 and the collaborative client 1032 are each configured to update a local model in their own collaborative client based on the first model result and respectively obtain an updated result, and send feedback information to the server based on the updated result.

The local model has the same structure and parameter information as the virtual device, and the feedback information comprises an approved opinion and a disapproved opinion.

The server 101 is configured to determine whether a proportion of the approved opinion in the feedback information exceeds a second preset value; if yes, the parameter information is updated in the virtual device based on the first model result to obtain an updated parameter information as a second parameter information. The server is further configured to determine whether the first model result is correct based on the second parameter information; if yes, a confirmation message is respectively sent to the collaborative client 1031 and the collaborative client 1032 to continue the multiplayer collaborative task.

In the above technical solution, the virtual device represents a processing object for the multiplayer collaborative task. Specifically, the virtual device may be located in a virtual system in a number of one or more; or, the virtual device is a virtual system.

Based on the same inventive concepts, this application also provides a multiplayer collaborative task assurance method based on agent and backup technologies, which is applied to a sever of a multiplayer collaborative task assurance system based on agent and backup techniques. The multiplayer collaborative task assurance system further includes a target client, a server and one or more collaborative client.

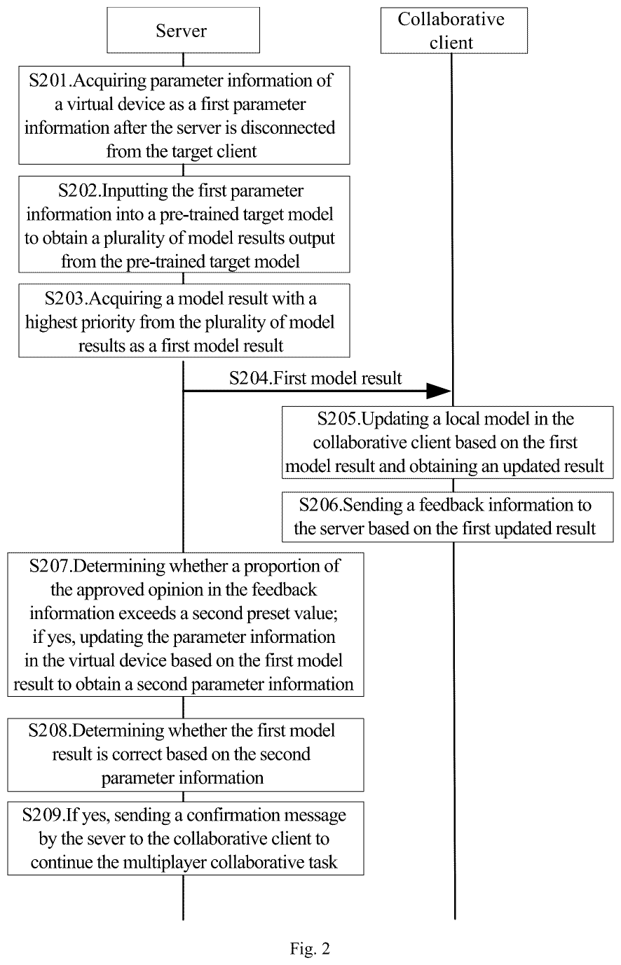

Referring to FIG. 2, FIG. 2 is an interactive diagram showing a multiplayer collaborative task assurance method according to an embodiment of the present disclosure. The method includes the following steps.

(S201) Parameter information of a virtual device is acquired as a first parameter information after it is determined that the server is disconnected from the target client, where the virtual device represents a processing object of a multiplayer collaborative task.

(S202) The first parameter information is input into a pre-trained target model to obtain a plurality of model results output from the pre-trained target model, where a user of any client corresponds to a pre-trained model belonging to the user; the target model represents a model of a user belonging to the target client; and the number of the plurality of model results is a first preset value.

(S203) A model result with a highest priority is acquired from the plurality of model results as a first model result.

(S204) The first model result is sent to the collaborative client.

(S205) The collaborative client updates a local model in the collaborative client based on the first model result and obtain an updated result, where the local model has the same structure and parameter information as the virtual device.

(S206) Feedback information is sent to the server based on the first updated result, where the feedback information includes an approved opinion and a disapproved opinion.

(S207) Whether a proportion of the approved opinion in the feedback information exceeds a second preset value is determined by the sever; if yes, the parameter information in the virtual device is updated based on the first model result to obtain updated parameter information as a second parameter information.

(S208) whether the first model result is correct is determined by the sever based on the second parameter information.

(S209) If yes, a confirmation message is sent to the collaborative client to continue the multiplayer collaborative task.

Based on the aforementioned steps, after the target client is disconnected from the server, the pre-trained target model in the server is configured to simulate the operation of the user of the target client to update the parameter information of the virtual device, thus guaranteeing the smooth and efficient conduct of the multiplayer collaborative task. At the same time, based on the feedback information of the collaborative client and the confirmation operation of the server, whether the model results output by the selected pre-trained target model are correct is judged, thereby verifying the feasibility of the updated parameter information of the virtual device, and avoiding deviation in the process of carrying out the multiplayer collaborative task.

In some embodiments, the multiplayer collaborative task assurance method also includes the following steps.

When a user joins the multiplayer collaborative task for the first time, the server constructs a user object for the user.

When the user joins the multiplayer collaboration task for the first time, the client used by the user serves as the initial client. The user sends its own user data information to the server through the initial client and applies for registration of the user object.

The user object includes the user data information of the user. The user data information includes position, work number, user object name, contact information of the user. The user object represents a local user role that performs the multiplayer collaborative task.

When the server confirms that the user data information is correct, it constructs the user object of the user and grants the user a corresponding range of permissions based on the user data information. Among them, based on the work number in the user data information, the server confirms the authenticity of the user data information; and based on the work number and position of the user, the server grants the user object a different range of permissions.

For example, if the user is determined to be a supervisor of the multiplayer collaborative task based on the work number and position of the user in the user data information, the user object has the operation authority to view and modify all of the equipment in the virtual system. If the user is determined to be an operator of the lathe equipment in the multiplayer collaborative task based on the work number and position of the user, the user object has the operation authority to operate only the virtual lathe equipment in the virtual system.

Based on the above processing, the range of permissions of different user objects is standardized. Due to different ranges of permissions for different users, the influence of operations between different users is reduced, which ensures the safety of the multiplayer collaborative task while reducing the error of the user's operational behavior.

In addition, the time point when the user first joins the multiplayer collaborative task can be the starting stage or during the processing of the multiplayer collaborative task, which is not limited herein.

When the user object is successfully created, the server sends an owner message to the initial client, giving the user an operation authority on the user object in the initial client. In the embodiment of the present disclosure, the target user object represents the user object of the target client, and the collaborative user object represents the user object of the collaborative client.

If the user object has been constructed when the user joins the multiplayer collaborative task, the server wakes up the user object based on the user data information sent by the user to the server via the client. Then, the server sends an owner message to the client, so that the user has the operation authority for the user object in the client.

After the user object is constructed, the server backs up the constructed user object as a backup user object and sends the backup user object to the remaining clients.

Based on the user data information in the backup user object, users of different clients can query the contact information of other users, facilitating communication between different users during the multiplayer collaborative task.

In the embodiment provided by the present disclosure, the server includes a backup target user object and a backup collaborative user object. The target client includes a target user object and a backup collaborative user object. The collaborative client includes a collaborative user object and a backup target user object.

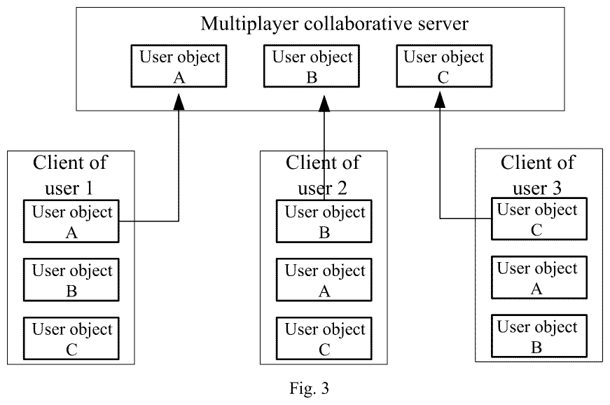

FIG. 3 schematically shows a multiplayer collaborative mechanism provided by an embodiment of the present disclosure. As shown in FIG. 3, a multiplayer collaborative server (i.e., the server of the present disclosure) includes a plurality of backup user objects, namely, user object A of user 1, user object B of user 2, and user object C of user 3.

The user client 1 includes a user object A, a user object B, and a user object C, where the user object A is a local user role of the user client 1, and the user object B and the user object C are backup user roles. The user client 1 has the operation authority of the user object A. After the user client 1 is connected to the multiplayer collaborative server, the user 1 operates the virtual device in the multiplayer collaborative task according to the scope of authority of the user object A.

Similarly, the user client 2 includes a user object A, a user object B, and a user object C. The user object B is a local user role of the user client 2, and the user object A and the user object C are backup user roles. The user client 3 includes a user object A, a user object B, and a user object C. The user object C is a local user role of the user client 3, and the user object A and the user object B are backup user roles.

In some embodiments, when the server is not disconnected from the target client, the multiplayer collaborative task assurance method includes the following steps.

(S1) The server receives an operation instruction sent by the target client as a first operation instruction.

(S2) Based on the first operation instruction, the server updates parameters of the virtual device and obtains updated parameter information as the third parameter information.

(S3) Based on the third parameter information, the server determines whether the first operation instruction is correct.

(S4) If yes, the third parameter information and the first operation instruction are stored into a database in the server, and the first operation instruction is sent to the target client and the collaborative client to enable the target client and the collaborative client to store the first operation instruction and update the local model based on the first operation instruction.

Specifically, during the multiplayer collaborative task, when a user completes an operation in the target client, the operation will be sent to the server from the target client in the form of an operation instruction, where the operation instruction contains information such as the user object identification (ID) of the user of the operation, the virtual device ID of the operation, the part ID of the operation, the type of operation (e.g., position movement, temperature adjustment, etc.), and the data related to the operation (e.g., the displacement amount of a certain part, the adjustment value of the temperature in the virtual system, etc.).

The server receives the operation instruction sent by the target client as the first operation instruction. According to the first operation instruction, the server updates the parameter information of the virtual device in the virtual system to obtain the updated parameter information as the third parameter information.

The parameter information of the virtual device includes ID of the virtual device, coordinates of a spatial location of the virtual device, ambient temperature of the virtual device, operating time of the virtual device, operating state of the virtual device, noise value of the virtual device, number of parts of the virtual device, ID of part 1, relative coordinates of the part 1, corresponding rotational angle of the part 1, deformation data of the part 1, and state of the part 1.

For step (S3), based on the third parameter information, the server determines whether the first operation instruction is correct. In an embodiment, a certain user is set as an administrator of the server in advance during the multiplayer collaborative task, and the administrator judges whether the first operation instruction is feasible based on the obtained third parameter information. Alternatively, the server judges whether the obtained third parameter information meets the preset task requirements. For example, the requirements of the multiplayer collaborative task include a requirement for an operating temperature interval of the virtual device, and the operating temperature interval is required to be 0-30° C. If the temperature in the third parameter information acquired by the server is 40° C., it indicates that the third parameter information does not meet the preset task requirements, i.e., the first operation instruction is incorrect.

In an embodiment, based on the third parameter information, whether the first operation instruction is correct is determined:
if not, the operation of updating the parameters of the virtual device based on the first operation instruction is revoked by the server; and
an error confirmation message is sent to the target client to enable the target client to adjust the first operation instruction and resend the adjusted first operation instruction to the server.

Regarding step (S4), the server parses the first operation instruction into structured data and stores the structured data and the updated parameter information together into a multiplayer collaborative operation database in the server. Specifically, the structured data corresponding to the operation instruction is stored in the form of fields in a data table, and different operation instructions are classified according to the user object ID.

The server sends a plurality of data, such as the confirmation result, the structured data corresponding to the first operation instruction, and the update record of the parameter information of the virtual device, to the remaining clients (including the target client and the collaborative client).

After receiving the above data, the remaining clients update the local model of the virtual system in the client. The operation record corresponding to the first operation instruction is displayed on the front-end page of the client, and at the same time, the record is added to the multiplayer collaborative operation record file on the client for querying. Specifically, the multiplayer collaborative operation record file is represented as a log file with a txt format.

Based on the above processing, the server synchronizes operation instructions sent by each client and parameter changes of the virtual device to all the clients. In this way, the above information can be backed up while ensuring the real-time data synchronization in the multiplayer collaborative task. It also facilitates to query operation instructions of other users and the parameter changes of the virtual device in real time through the client when a user is operating the virtual device, which provides references for the operation instructions issued by the user.

For step (S201), the parameter information of the virtual device and the operation instructions of the user object are stored in the multiplayer collaborative database in the server in the form of sql. The parameter information of the virtual device is obtained by the server through the following steps. Based on an ID of the multiplayer collaborative task, the server obtains the parameter information of the virtual device corresponding to the multiplayer collaborative database as the first parameter information.

For step (S202), the server inputs the first parameter information to the pre-trained target model, and obtains a plurality of model results output by the pre-trained target model, where the plurality of model results output by the target model are expressed as ternary vector, and the ternary vector is a sorted vector including a problem locating position, an operation type, and an operation-related data. The problem location position represents the part ID number and position coordinates of the virtual device or a virtual part adjusted in the virtual system. The operation type represents different types of operations, such as part movement, button operation, cable connection, and part welding. The operation-related data represents specific values for adjusting the virtual device or the virtual part.

In addition, the number of the plurality of model results is a first preset value, and the first preset value can be set by the user in advance, which can be 2, 3, 5, etc., and is not specifically limited herein.

The training of the corresponding models for different clients is exemplified by the target model of the target client in the embodiment of the present disclosure. The target model is a long and short-term memory (LSTM) model in a recurrent neural network. Based on the object ID of the target user object, the server obtains the first operation instruction under the object ID in the data table, and obtains the parameter information of the virtual device corresponding to the operation based on each of the first operation instructions, which are used as the training samples of the LSTM model. The LSTM model is trained and iterated through the training samples to optimize the parameters of the target model.

When the training samples are not accumulated to a certain number, a data enhancement algorithm may be used to further increase the number of training samples. For example, in the case that part 1 is 1 cm to the left, the operation instruction of the user is to adjust the part 1 to the right by 1 cm, then another training sample can be derived as: part 1 is 2 cm to the left, and the corresponding operation instruction of the user is to adjust the part 1 to the right by 2 cm.

Since operation instructions issued by different users are different, the training samples of the LSTM model of each user object are different. Therefore, the model parameters of the trained LSTM model of each user object are different, i.e., each user role of each user corresponds to a respective LSTM model.

For step (S203), the server determines the model result with the highest priority among the plurality of model results as the first model result.

Then, the server sends the first model result to the collaborative client so that the collaborative client updates the local model in the collaborative client based on the received first model result, and obtains the updated result. Based on the updated result, the collaborative client sends feedback information to the server.

The local model has the same structure and parameter information as the virtual device in the server. The feedback information includes an approved opinion and a disapproved opinion.

Since the local model has the same structure and parameter information as the virtual device in the server, a user of any client can observe the latest state of the virtual device in real time through the status of the local model, i.e., the client can observe the latest state of the virtual device without a network transmission, and thus does not need to take up too much network bandwidth, which effectively guarantees the transmission rate between the client and the server in the multiplayer collaborative task.

For step (S207), the server determines whether the proportion of the approved opinion in the received feedback information exceeds the second preset value; if yes, the parameter information in the virtual device is updated based on the first model result to obtain the updated parameter information as the second parameter information, where the second preset value is 0-1, which can be adjusted according to the degree of importance of the multiplayer collaborative task.

If the proportion of approved opinions exceeds the second preset value, it indicates that the output results of the target model are approved by the collaborative client.

If the degree of importance of the multiplayer collaborative task is high, the second preset value may be increased to ensure that the output result is approved by a larger number of users, thus reducing the deviation during the execution of the multiplayer collaborative task. If the degree of importance of the multiplayer collaborative task is low, the second preset value can be lowered such that the multiplayer collaborative task can be carried out when the approved opinions are few, thereby enhancing the processing efficiency of the multiplayer collaborative task and shortening completion time. In practice, the second preset value may be ⅔, ⅗, etc., and is not specifically limited herein.

For step (S208), the server confirms whether the first model result is correct based on the second parameter information.

If yes, the server sends a correctness confirmation message to the collaborative client and continues to carry out the multiplayer collaborative task.

Whether the proportion of the approved opinion in the received feedback information exceeds the second preset value is determined.

If not, the server sends a revocation instruction to the collaborative client to enable the collaborative client to revoke the operation of updating the local model.

Based on the priority order of the model results, one of the model results is selected round by round to replace the first model result to obtain a plurality of replaced model result. Each of the plurality of replaced model results is sent to the collaborative client to re-update the local model based on each of the plurality of replaced model results and obtain a plurality of updated results. Feedback information is re-sent to the server based on the plurality of updated results.

If the proportion of the approved opinion in the second feedback information received by the server exceeds a second preset value after one of the model results replaces the first model result, the parameter information in the virtual device is updated based on the replaced model results to obtain updated parameter information as the second parameter information.

If the proportion of the approved opinion in the second feedback information received by the server fails to exceed the second preset value after each of model results replaces the first model result, then the multiplayer collaborative task is paused, and a proceeding confirmation instruction is sent to the collaborative client, so as to enable the collaborative client to determine whether the multiplayer collaborative task is continued.

It is understood that after confirming, based on the second parameter information, whether the first model result or the replaced first model result is correct, if it is not correct, the server revokes the operation of updating the parameter information in the virtual device and sends a revocation instruction to the collaborative client to allow the collaborative client to revoke the operation of updating the local model. The server re-selects, based on the priority order of the model results, the model results one by one to replace the first model result and sends replaced model results to the collaborative client, so that the collaborative client re-updates the local model based on the received replaced model results to obtain the updated results, and re-sends the feedback information to the server based on the updated results.

In practice, when the target client is disconnected from the server, the server initiates a confirmation poll to the collaborative client, and the remaining users in the multiplayer collaborative task participates in the confirmation. If ⅔ or more of the total number of users agree with the operation of the target model in the server, the operation is passed. If the above operation is not passed, the current operation is withdrawn by the server and the operation ranked second in the classification result set (i.e., the output result of the target model) is selected for execution, and the confirmation vote is initiated again until the operation is passed.

If the operation still does not pass after three consecutive operations have been executed, the target model in the server no longer automatically executes the operation, and the other users in the current multiplayer collaborative task decide the next step of processing, including continuation of the task, interruption of the task, or exit of the task.

In some embodiments, after the target client is reconnected with the server, the multiplayer collaborative task assurance method further includes the following steps:
after reconnecting with the target client, the server receives a re-connection instruction sent by the target client, where the re-connection instruction includes a task ID of a multiplayer collaborative task and an operation sequence number of the last operation instruction sent by the target client before disconnecting; and
based on the task ID and the operation sequence number, the server synchronizes all operation information located after the operation sequence number in the task ID to the target client.

In practice, if the user reconnects to the multiplayer collaborative task, the user applies to the server for the permissions of the user object and transfers the control of the user object on the server to the user to enable the user to continue to participate in the current multiplayer collaborative task if the multiplayer collaborative task is still in progress.

After the user has regained the permissions, the client of the user will automatically send to the server the task ID of the current multiplayer collaborative task and the operation sequence number of the last operation record of the user when the user last participates in the multiplayer collaborative task. After receiving the above information, the server will push all new operation data information after the operation to the client, and the user can obtain and view the historical operation records on the current page of the system.

In some embodiments, whether the server is disconnected from the target client is determined through the following steps:
the server determines disconnection the server and the target client according to a heartbeat mechanism; or
the server receives a disconnection instruction sent by the target client for disconnecting from the target client.

In an implementation, the server separately constructs heartbeat connections with each client when the multiplayer collaboration task is on. For example, a client sends a heartbeat request to the server every 3 s through a long connection channel. If the act of sending a heartbeat request by a client fails five times in a row, it indicates that the client is disconnected from the server.

In an implementation, when a user faces an unexpected incident and is unable to continue to participate in the multiplayer collaborative task, the user may use the client to actively send a disconnection instruction to the server. When the server receives the disconnection instruction from the client, it can directly confirm that the client is disconnected.

To ensure the security of the multiplayer collaborative task, before the client disconnects from the server, the user should actively choose whether the model corresponding to the client can continue to execute the multiplayer collaborative task instead of the user.

Based on the above processing, when the user quits abnormally due to disconnection from the network or hardware failures, the model corresponding to the client is set in advance to replace the user in the case of abnormal quitting; or when the user has other tasks to be dealt with temporarily, the user can actively choose the model corresponding to the client to replace the user.

In the above scenarios, the operation authority of the user object will be automatically alienated to the server, such that the server will automatically operate when the user is required to perform operation processing according to the pre-trained algorithmic model corresponding to the user object. When the user reconnects to the multiplayer collaborative task, the server will judge the ID information of the user, automatically match the user object of the user, transfer the authority of the user object to the user itself again, and continue to record operation instructions of the user and the parameter information change of the corresponding virtual device each time.

In some embodiments, when a certain collaborative client is disconnected from the server, information such as operation instructions in the server cannot be transferred to the collaborative client, and the multiplayer collaborative task proceeds normally. When the collaborative client is reconnected, the server synchronizes the relevant information to the collaborative client. If this collaborative client is still not reconnected with the server when it is transformed into the target client, it is processed based on the above technical solution.

In addition, when the target client is disconnected from the server, the disconnected collaborative client is unable to provide feedback information, and the server does not consider the feedback information of the collaborative client.

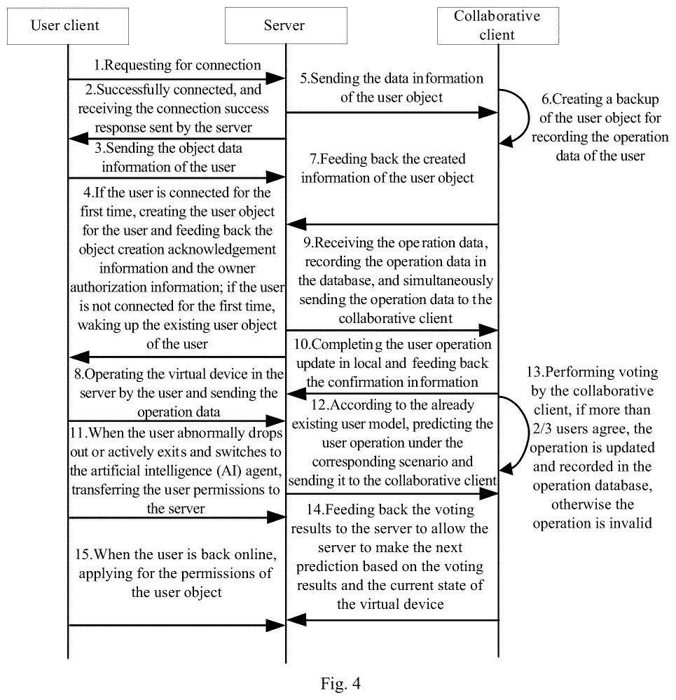

FIG. 4 shows a timing diagram of a multiplayer collaborative mechanism provided by an embodiment of the present disclosure, and the corresponding workflow is described as follows.

(1) The user sends a connection request to the server using a used client (i.e., the user client).

(2) When the server is successfully connected with the user client, the user client receives the connection success response sent by the server.

(3) The user client sends the object data information of the user to the server.

(4) If the user connects for the first time, the server creates the user object and feeds back the object creation acknowledgement information and the owner authorization information. If the user is not connected for the first time, the server wakes up the existing user object of the user.

(5) The server sends the data information of the user object to the collaborative client.

(6) The collaborative client makes a backup of the received user object for recording the operation data of the user.

(7) The collaborative client feeds back the created information of the user object to the server.

(8) The user operates the virtual device in the server through the user client and sends the operation data to the server.

(9) The server receives the operation data, records the operation data in the database, and simultaneously sends the operation data to the collaborative client.

(10) The collaborative client completes the user operation update of the user in the local client and feeds back the confirmation information to the server.

(11) The user abnormally drops out or actively exits and switches to the artificial intelligence (AI) agent (i.e., the user is replaced by the trained target model in the present disclosure), and the user rights are transferred to the server.

(12) According to the already existing user model, the user operation under the corresponding scenario is predicted and sent to the collaborative client.

(13) According to the voting mechanism in the present disclosure, other users initiate a vote. If more than ⅔ users agree, the operation is updated and recorded in the operation database, otherwise the operation is invalid.

(14) The collaborative client feeds back the voting results to the server, and the server makes the next prediction based on the voting results and the current state of the virtual device.

(15) When the user is back online, the user applies for the permissions of the user object.

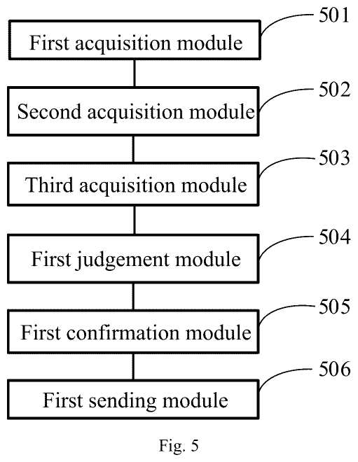

Based on the same inventive conceptions, this application further provides a multiplayer collaborative task assurance device, which is applied to a sever of a multiplayer collaborative task assurance system based on agent and backup techniques. The multiplayer collaborative task assurance system further includes a target client, a server and a collaborative client. FIG. 5 is a structural diagram of a multiplayer collaborative task assurance device based on agent and backup techniques provided by an embodiment of the present disclosure, which includes a first acquisition module 501, a second acquisition module 502, a third acquisition module 503, a first judgement module 504, a first confirmation module 505 and a first sending module 506.

The first acquisition module 501 is configured to acquire parameter information of a virtual device as a first parameter information after the server is determined to be disconnected from the target client, where the virtual device represents a processing object of a multiplayer collaborative task.

The second acquisition module 502 is configured to input the first parameter information into a pre-trained target model to obtain a plurality of model results output from the pre-trained target model, where a user of any client corresponds to a pre-trained model belonging to the user; the target model represents a model of a user belonging to the target client.

The third acquisition module 503 is configured to acquire a model result with a highest priority from the plurality of model results as a first model result, send the first model result to the collaborative client to allow the collaborative client to update a local model in the collaborative client based on the first model result and obtains an updated result, and send a feedback information to the server based on the updated result, where the local model has the same structure and parameter information as the virtual device; the feedback information includes an approved opinion and a disapproved opinion; and the number of the plurality of model results is a first preset value.

The first judgement module 504 is configured to judge whether a proportion of the approved opinion in the feedback information exceeds a second preset value; if yes, the parameter information in the virtual device is updated based on the first model result to obtain a second parameter information.

The first confirmation module 505 is configured to confirm whether the first model result is correct based on the second parameter information.

The first sending module 506 is configured to send a confirmation message to the collaborative client to continue the multiplayer collaborative task after the first model result is confirmed to be correct.

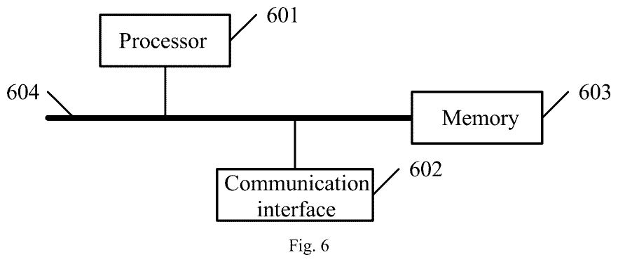

This application also provides an electronic device, as shown in FIG. 6, which includes a processor 601, a communication interface 602, a memory 603 and a communication bus 604, where the processor 601, the communication interface 602 and the memory 603 are in communication with each other via the communication bus 604; the memory 603 is configured to store a computer program; and the processor 601 is configured to execute the computer program stored on the memory to implement the aforementioned multiplayer collaborative task assurance method.

The communication buses mentioned above for the electronic device can be peripheral component interconnect (PCI) buses or extended industry standard architecture (EISA) buses. This communication buses can be classified as an address bus, a data bus, a control bus, etc. For ease of representation, only one thick line is illustrated in the drawings, but it does not mean that there is only one bus or one type of bus.

The communication interface is used for communication between the above electronic device and other devices.

The memory may include a random-access memory (RAM) or may include a non-volatile memory (NVM), such as at least one disc memory. Optionally, the memory may also be at least one storage device located away from the aforementioned processor.

The aforementioned processor may be a general-purpose processor, including a central processing unit (CPU) and a network processor (NP). It may also be a digital signal processor (DSP), an application specific integrated circuit (ASIC), a field-programmable gate array (FPGA) or other programmable logic devices, a discrete gate or a transistor logic device, or a discrete hardware component.

In an embodiment, this application further provides a computer-readable storage medium, which is configured to store a computer program. The computer program is configured to be executed by a processor to implement the aforementioned multiplayer collaborative task assurance method.

In an embodiment, this application further provides a computer program product containing instructions. When the computer program product is executed on a computer, the computer implements the aforementioned multiplayer collaborative task assurance method based on agent and backup techniques.

The above embodiment may be implemented in whole or in part by software, hardware, firmware, or any combination thereof. When implemented using software, it may be implemented, in whole or in part, in the form of a computer program product. The computer program product includes one or more computer instructions. When loading and executing the computer program instructions on a computer, the computer produces, in whole or in part, processes or functions in accordance with embodiments of the present disclosure. The computer may be a general-purpose computer, a special-purpose computer, a computer network, or other programmable device. The computer instructions may be stored in a computer-readable storage medium or transmitted from one computer-readable storage medium to another computer-readable storage medium, e.g., the computer instructions may be transmitted wiredly (e.g., coaxial cable, fibre optic, digital subscriber line (DSL)) or wirelessly (e.g., infrared, wireless, microwave, etc.) from one website site, computer, server, or data center to another website site, computer, server or data center. The computer-readable storage medium may be any usable medium to which a computer has access or a data storage device including one or more usable media integrated server or data center. The usable medium may be a magnetic medium, (e.g., floppy disk, hard drive, tape), an optical medium (e.g., DVD), or a semiconductor medium (e.g., solid state disk Solid State Disk (SSD)).

In summary, compared with the prior art, the present disclosure has the following beneficial effects.

(1) After the target client is disconnected from the server, the pre-trained target model in the server is configured to simulate the operation of the user of the target client to update the parameter information of the virtual device, thus guaranteeing the smooth and efficient conduct of the multiplayer collaborative task. At the same time, based on the feedback information of the collaborative client and the confirmation operation of the server, whether the model results output by the selected pre-trained target model are correct is judged, thereby verifying the feasibility of the updated parameter information of the virtual device, and avoiding deviation in the process of carrying out the multiplayer collaborative task.

(2) Based on the above processing, the scope of authority of different user objects is regulated. Due to the different scope of authority of different users, the influence of operations between different users is reduced, and the safety of the multiplayer collaborative task is ensured while reducing the errors of user operation behavior.

It should be noted that as used herein, relationship terms, such as “first” and “second”, are merely used to distinguish one entity or operation from another entity or operation, and do not necessarily require or imply the existence of any such actual relationship or order between these entities or operations. Further, the terms “including”, “comprising”, or any other variant thereof, are intended to cover non-exclusive inclusion, such that a process, method, article, or apparatus including a set of elements includes not only those listed elements, but also other elements not expressly listed, or other elements inherent to such process, method, article or apparatus. Without further limitation, the element defined by the phrase “includes a . . . ” does not preclude the existence of additional identical elements in the process, method, article or apparatus that includes the element.

The above embodiments are merely used to illustrate the technical solutions of the present disclosure, and are not intended to limit the present disclosure. Although the present disclosure has been described in detail with reference to the foregoing embodiments, one of ordinary skill in the art should understand that it is still possible to make modifications to the technical solutions recorded in the foregoing embodiments or to make equivalent replacements for some of the technical features therein. Such modifications or replacements made without departing from the spirit and scope of the present disclosure shall fall within the scope of the disclosure defined by the appended claims.

What is claimed is:

1. A multiplayer collaborative task assurance system based on agent and backup techniques, comprising:
a server;
a target client; and
a collaborative client;
wherein the server is configured to perform:
obtaining parameter information of a virtual device as a first parameter information after determining to be disconnected from the target client;
inputting the first parameter information into a pre-trained target model to obtain a plurality of model results output from the pre-trained target model; and
acquiring a model result with a highest priority among the plurality of model results as a first model result, and sending the first model result to the collaborative client;
wherein a user of any client corresponds to a pre-trained model belonging to the user; the target model represents a model of a user belonging to the target client; the virtual device represents a processing object of a multiplayer collaborative task; and the number of the plurality of model results is a first preset value;
the collaborative client is configured to perform:
updating a local model in the collaborative client based on the first model result and obtaining an updated result; and
sending feedback information to the server based on the updated result;
wherein the local model has the same structure and parameter information as the virtual device, and the feedback information comprises an approved opinion and a disapproved opinion; and
the server is configured to perform:
determining whether a proportion of the approved opinion in the feedback information exceeds a second preset value;
if yes, updating the parameter information in the virtual device based on the first model result to obtain an updated parameter information as a second parameter information; and determining whether the first model result is correct based on the second parameter information; if yes, sending a confirmation message to the collaborative client to continue the multiplayer collaborative task.

2. A multiplayer collaborative task assurance method based on agent and backup techniques, being applied to a sever of a multiplayer collaborative task assurance system based on agent and backup technologies, the multiplayer collaborative task assurance system further comprising a target client and a collaborative client, and the multiplayer collaborative task assurance method comprising:
acquiring parameter information of a virtual device as a first parameter information after it is determined that the server is disconnected from the target client, wherein the virtual device represents a processing object of a multiplayer collaborative task;
inputting the first parameter information into a pre-trained target model to obtain a plurality of model results output from the pre-trained target model, wherein a user of any client corresponds to a pre-trained model belonging to the user; the target model represents a model of a user belonging to the target client; and the number of the plurality of model results is a first preset value;
acquiring a model result with a highest priority from the plurality of model results as a first model result, and sending the first model result to the collaborative client such that the collaborative client updates a local model in the collaborative client based on the first model result and obtains a first updated result; and sending a first feedback information to the server based on the first updated result; wherein the local model has the same structure and parameter information as the virtual device, and the first feedback information comprises an approved opinion and a disapproved opinion;
determining whether a proportion of the approved opinion in the feedback information exceeds a second preset value; if yes, updating the parameter information in the virtual device based on the first model result to obtain a second parameter information; and
determining whether the first model result is correct based on the second parameter information; if yes, sending a confirmation message to the collaborative client to continue the multiplayer collaborative task.

3. The multiplayer collaborative task assurance method of claim 2, further comprising:
if the proportion of the approved opinion in the feedback information does not exceed the second preset value, sending an undo instruction to the collaborative client to allow the collaborative client to cancel an operation of updating the local model;
selecting the plurality of model results one by one to replace the first model result according to a priority order among the plurality of model results to obtain a plurality of second model results; sending each of the plurality of second model results to the collaborative client to re-update the local model based on each of the plurality of second model results and obtain a plurality of second updated results; and re-sending a second feedback information to the server based on the plurality of second updated results;
if a proportion of the approved opinion in the second feedback information received by the server exceeds the second preset value after the first model result is replaced with one of the plurality of model results, updating the parameter information in the virtual device based on the one of the plurality of model results to obtain an updated parameter information as the second parameter information; and
for all of the plurality of second model results, if the proportion of the approved opinion in the second feedback information received by the server does not exceed the second preset value, pausing the multiplayer collaborative task and sending a confirmation instruction to the collaborative client to allow the collaborative client to determine whether to continue the multiplayer collaborative task.

4. The multiplayer collaborative task assurance method of claim 2, wherein whether the server is disconnected from the target client is determined through steps of:
determining, by the server, to be disconnected from the target client according to a heartbeat mechanism; or
receiving, by the server, a disconnection instruction sent by the target client.

5. The multiplayer collaborative task assurance method of claim 2, further comprising:
when a user joins the multiplayer collaborative task for the first time, obtaining user data information of the user and constructing a user object of the user; wherein user objects of different users have different ranges of permissions to perform the multiplayer collaborative task; and a target user object represents a user object of the target client, and a collaborative user object represents a user object of the collaborative client;
backing up the user object as a backup user object; and sending the backup user object to remaining clients; wherein the server comprises a backup target user object and a backup collaborative user object; the target client comprises the target user object and the backup collaborative user object, and the collaborative client comprises the collaborative user object and the backup target user object;
when the server is not disconnected from the target client, receiving an operation instruction sent by the target client as a first operation instruction;
based on the first operation instruction, updating the parameter information of the virtual device to obtain a third parameter information; and
based on the third parameter information, determining whether the first operation instruction is correct; if yes, storing the third parameter information and the first operation instruction into a database of the server, and sending the first operation instruction to the target client and the collaborative client to allow the target client and the collaborative client to store the first operation instruction and update the local model based on the first operation instruction.

6. The multiplayer collaborative task assurance method of claim 5, further comprising:
if the first operation instruction is incorrect, undoing, by the server, an operation of updating the parameter information of the virtual device based on the first operation instruction; and
sending an error confirmation message to the target client such that the target client adjusts the first operation instruction and sends an adjusted first operation instruction to the server.

7. The multiplayer collaborative task assurance method of claim 2, further comprising:
after reconnected with the target client, receiving, by the server, a re-connection instruction sent by the target client; wherein the re-connection instruction comprises a task identification (ID) of the multiplayer collaborative task and an operation sequence number of a last operation instruction sent by the target client before disconnection; and
based on the task ID and the operation sequence number, synchronizing, by the server, information of all operations after the operation sequence number in the task ID to the target client.

8. A multiplayer collaborative task assurance device, being applied to a sever of a multiplayer collaborative task assurance system based on agent and backup techniques, the multiplayer collaborative task assurance system further comprising a target client and a collaborative client, wherein the multiplayer collaborative task assurance device comprises:
a first acquisition module;
a second acquisition module;
a third acquisition module;
a judgement module;
a confirmation module; and
a sending module;
wherein the first acquisition module is configured to acquire parameter information of a virtual device as a first parameter information after the server is determined to be disconnected from the target client, wherein the virtual device represents a processing object of a multiplayer collaborative task;
the second acquisition module is configured to input the first parameter information into a pre-trained target model to obtain a plurality of model results output from the pre-trained target model, wherein a user of any client corresponds to a pre-trained model belonging to the user; the target model represents a model of a user belonging to the target client; and the number of the plurality of model results is a first preset value;
the third acquisition module is configured to acquire a model result with a highest priority from the plurality of model results as a first model result, send the first model result to the collaborative client to allow the collaborative client to update a local model in the collaborative client based on the first model result and obtain an updated result, and send a feedback information to the server based on the updated result; wherein the local model has the same structure and parameter information as the virtual device, and the feedback information comprises an approved opinion and a disapproved opinion;
the judgement module is configured to perform:
judging whether a proportion of the approved opinion in the feedback information exceeds a second preset value; and
if yes, updating the parameter information in the virtual device based on the first model result to obtain a second parameter information;
the confirmation module is configured to confirm whether the first model result is correct based on the second parameter information; and
the sending module is configured to send a confirmation message to the collaborative client to continue the multiplayer collaborative task after the first model result is confirmed to be correct.

9. An electronic device, comprising:
a processor;
a communication interface;
a memory; and
a communication bus;
wherein the processor, the communication interface and the memory are in communication with each other via the communication bus;
the memory is configured to store a computer program; and
the processor is configured to execute the computer program stored on the memory to implement the multiplayer collaborative task assurance method of claim 2.

10. A computer-readable storage medium, wherein the computer-readable storage medium is configured to store a computer program, and the computer program is configured to be executed by a processor to implement the multiplayer collaborative task assurance method of claim 2.
